(19) United States
(12) Patent Application Publication
(10) Pub. No.: US 2023/0159033 A1
(43) Pub. Date: May 25, 2023

(54) HIGH FIDELITY DATA-DRIVEN MULTI-MODAL SIMULATION

(71) Applicant: MOTIONAL AD LLC, Boston, MA (US)

(72) Inventors: Austin Dill, Pittsburgh, PA (US); Yunming Shao, Fremont, CA (US); Silvio Maeta, Pittsburgh, PA (US); Arpit Jangid, Pittsburgh, PA (US)

(21) Appl. No.: 17/531,482

(22) Filed: Nov. 19, 2021

(51) Int. Cl. B60W 40/04; G06K 9/00; G06T 11/00; G06T 7/20; G05B 17/02; B60W 60/00

(52) U.S. Cl. CPC B60W 40/04; G06K 9/00791; G06T 11/00; G06T 7/20; G05B 17/02; B60W 60/0027; G06T 2207/10028; G06T 2207/10044; B60W 2420/52; B60W 2554/4029; B60W 2554/404

(57) ABSTRACT

Provided are methods for generating high fidelity synthetic sensor data representing hypothetical driving scenarios for the vehicle. Some methods described include accessing sensor data associated with operation of a vehicle in an environment traversing a first path. Operation of a simulated vehicle is simulated along a synthetic driving scenario in the simulated environment along a second path different from the first path and in simulation with the plurality of simulated agents. Systems and computer program products are also provided.

### BACKGROUND

Autonomous vehicles can include multiple sensors that produce sensor data about the vehicle and its environment. Light Detection And Ranging (LiDAR) sensors can emit pulsed light waves into a surrounding environment and can use a detector to determine information from light reflected by objects in the environment. Similarly, Radio Detection And Ranging (RADAR) sensors can determine object information from radio waves reflected by object in the environment after the waves are emitted by an emitter. Autonomous vehicles can use the LiDAR and RADAR information to traverse paths through the environment.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4A is a diagram of certain components of an autonomous system;

FIG. 4B is a diagram of an implementation of a neural network;

FIGS. 4C and 4D are a diagram illustrating example operation of a CNN;

FIG. 4E is a diagram illustrating an example of a generative adversarial network (GAN);

FIGS. 5A-5C are diagrams illustrating an example of an implementation of a process for high fidelity data-driven multi-modal simulation; and

FIG. 6 is a flowchart of a process for high fidelity data-driven multi-modal simulation.

### DETAILED DESCRIPTION

In the following description, numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

General Overview

In some aspects and/or embodiments, systems, methods, and computer program products described herein include and/or implement a process for high fidelity data-driven multi-modal simulation. Sensor data associated with operation of a vehicle in an environment it is accessing. The vehicle traverses a first path through the environment during the operation of the vehicle. Synthetic sensor data and a simulated environment are generated based on the sensor data associated with the operation of the vehicle. The simulated environment is based on real data and is configured to simulate synthetic environment conditions. A synthetic driving scenario is simulated in the simulated environment using the synthetic sensor data. Simulating the synthetic driving scenario includes simulating operation of simulated agents in the simulated environment and simulating operation of a simulated vehicle along a second path different from the first path and in simulation with the simulated agents. A simulated agent can be, for example, another autonomous vehicle. Simulating the synthetic driving scenario includes simulating zero or more environmental conditions in the synthetic driving scenario that are different from one or more environmental conditions present during the operation of the vehicle in the environment.

In some embodiments, a vehicle, such as an autonomous vehicle, can include multiple sensors that produce sensor data about the vehicle and its environment. The technology described here uses this sensor data to generate high fidelity synthetic sensor data representing hypothetical driving scenarios for the vehicle. In particular, image data, Light Detection And Ranging (LiDAR or lidar) data, and other sensor data produced by the vehicle's sensors are interpolated or otherwise modified to generate synthetic sensor data for novel vehicle trajectories and viewpoints. In some examples, the sensor data is augmented with data representing new objects (e.g., vehicles or pedestrians) or new behaviors or attributes for existing objects in order to generate the synthetic sensor data representing the driving scenario. Environmental conditions represented by the sensor data, such as weather conditions, road conditions, and/or time-of-day, can also be modified to generate the synthetic sensor data. Once generated, the synthetic sensor data can be used to simulate the operation of the vehicle through the hypothetical (or synthetic) driving scenario.

By virtue of the implementation of systems, methods, and computer program products described herein, techniques for facilitating the development and testing of autonomous vehicle systems by using real sensor data to generate high fidelity synthetic sensor data for novel driving scenarios. In particular, sensor data for edge-case (e.g., safety-critical) driving scenarios can be generated without the cost or risk of collecting such data by driving the vehicle. In addition, by leveraging real sensor data, the complexity of reconstructing the entire scenario in simulation is avoided, and higher fidelity is achieved relative to systems that rely on models to approximate the sensor data. The technology described here can also generate consistent sensor data in multiple modalities, such as image and lidar modalities, which results in more realistic simulation relative to systems that generate data in a single modality.

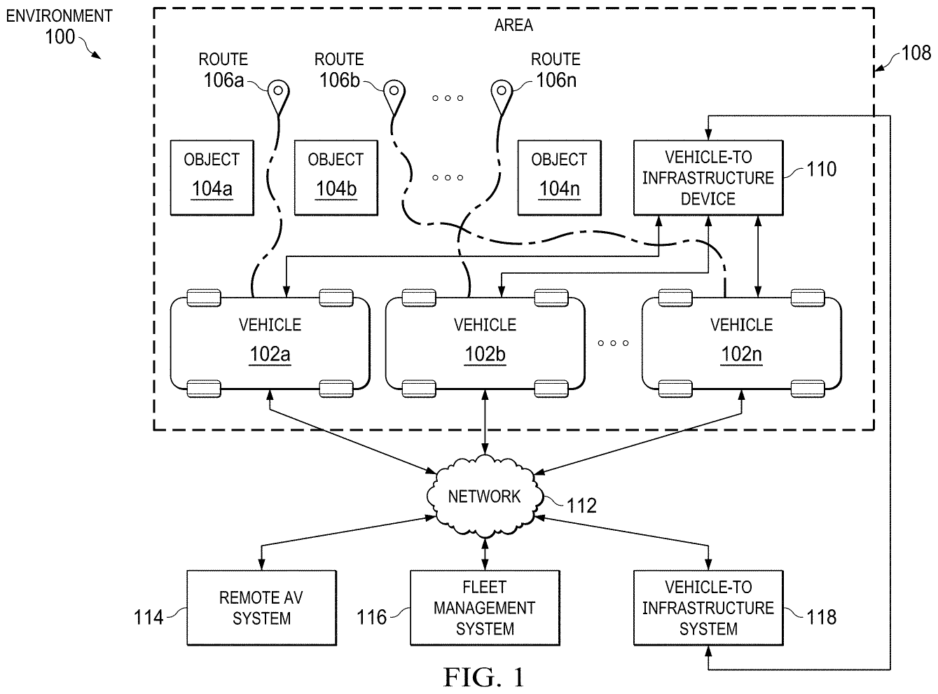

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

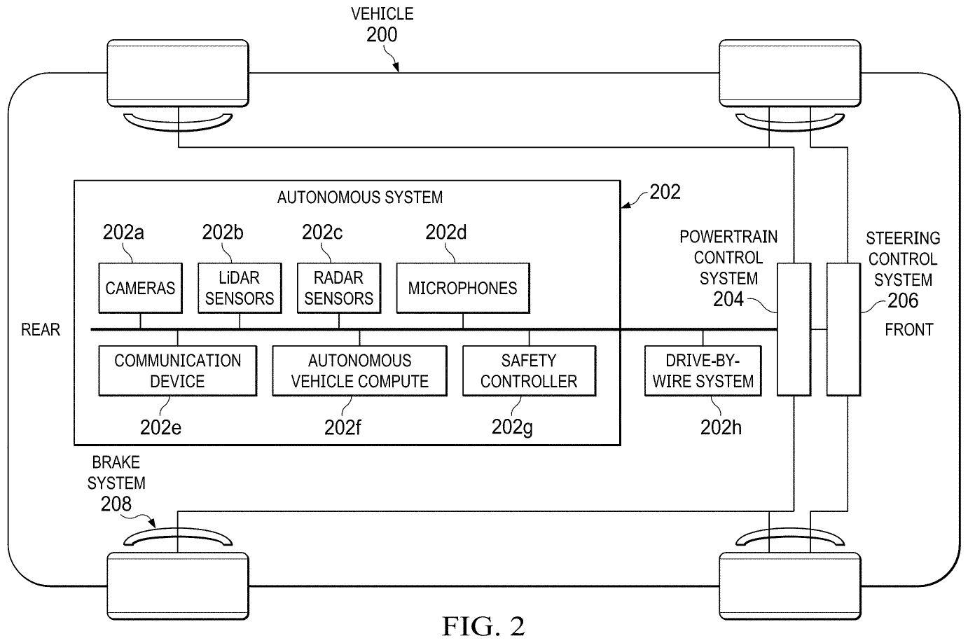

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited look-ahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, lidar sensors 202b, Radio Detection And Ranging (RADAR or radar) sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

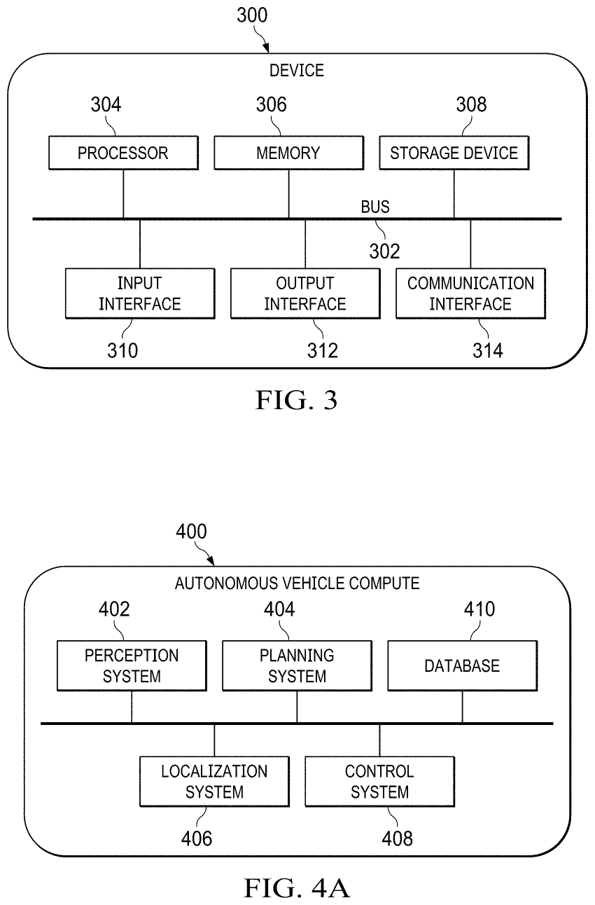

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates traffic light data (TLD) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Lidar sensors 202b include at least one device configured to be in communication with communication device 202e, autonomous vehicle compute 202f, and/or safety controller 202g via a bus (e.g., a bus that is the same as or similar to bus 302 of FIG. 3). Lidar sensors 202b include a system configured to transmit light from a light emitter (e.g., a laser transmitter). Light emitted by lidar sensors 202b include light (e.g., infrared light and/or the like) that is outside of the visible spectrum. In some embodiments, during operation, light emitted by lidar sensors 202b encounters a physical object (e.g., a vehicle) and is reflected back to lidar sensors 202b. In some embodiments, the light emitted by lidar sensors 202b does not penetrate the physical objects that the light encounters. Lidar sensors 202b also include at least one light detector which detects the light that was emitted from the light emitter after the light encounters a physical object. In some embodiments, at least one data processing system associated with lidar sensors 202b generates an image (e.g., a point cloud, a combined point cloud, and/or the like) representing the objects included in a field of view of lidar sensors 202b. In some examples, the at least one data processing system associated with lidar sensor 202b generates an image that represents the boundaries of a physical object, the surfaces (e.g., the topology of the surfaces) of the physical object, and/or the like. In such an example, the image is used to determine the boundaries of physical objects in the field of view of lidar sensors 202b.

Radar sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, lidar sensors 202b, radar sensors 202c, microphones 202d, autonomous vehicle compute 202f, safety controller 202g, and/or drive-by-wire (DBW) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, lidar sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, lidar sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one or more devices of network 112 (e.g., one or more devices of a system of network 112). In some embodiments, one or more devices of vehicles 102 (e.g., one or more devices of a system of vehicles 102), and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

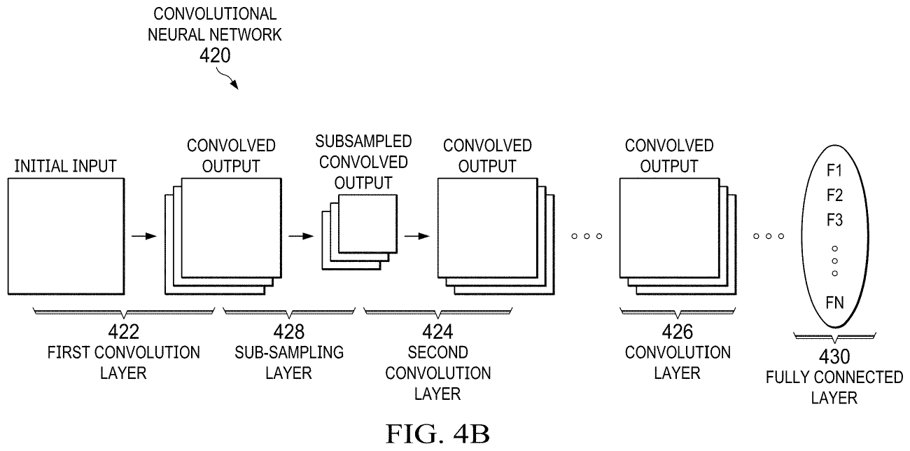

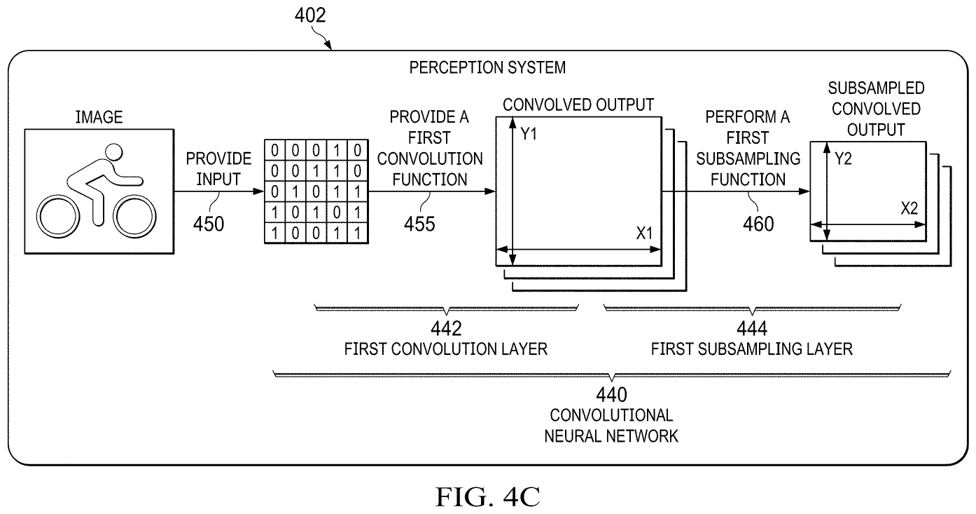

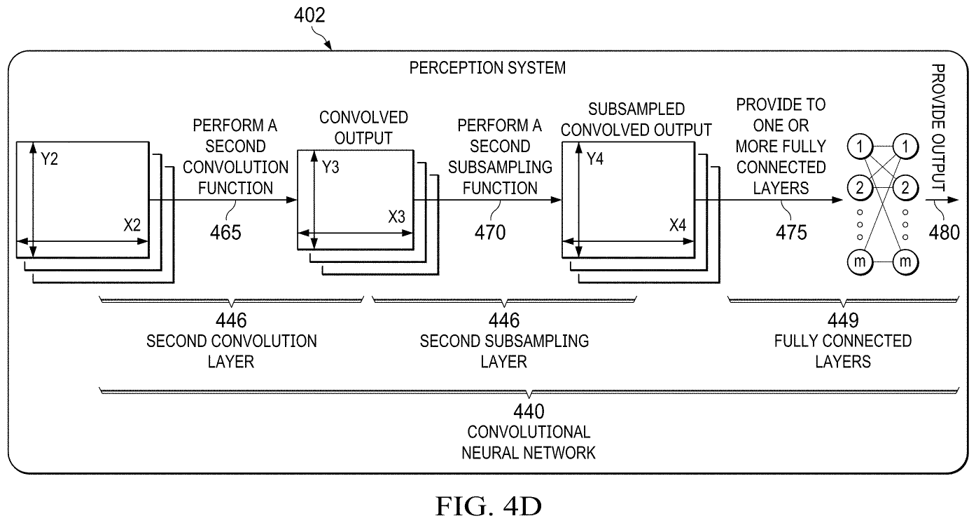

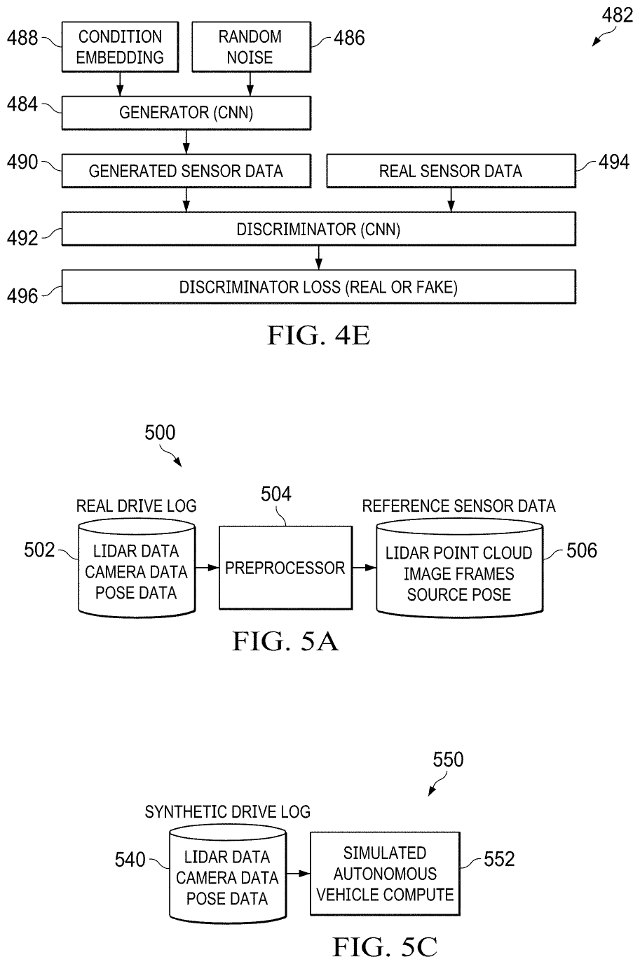

Referring now to FIG. 4A, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives lidar data associated with at least one point cloud generated by at least one lidar sensor (e.g., lidar sensors 202b). In certain examples, localization system 406 receives data associated with at least one point cloud from multiple lidar sensors and localization system 406 generates a combined point cloud based on each of the point clouds. In these examples, localization system 406 compares the at least one point cloud or the combined point cloud to a 2D and/or a 3D map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a GPS receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one auto-encoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a machine learning model is included below with respect to FIGS. 4B-4D.

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one lidar sensor (e.g., a lidar sensor that is the same as or similar to lidar sensors 202b) to generate data associated with an image representing the objects included in a field of view of the at least one lidar sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

Referring now to FIG. 4B, illustrated is a diagram of an implementation of a machine learning model. More specifically, illustrated is a diagram of an implementation of a CNN 420. For purposes of illustration, the following description of CNN 420 will be with respect to an implementation of CNN 420 by perception system 402. However, it will be understood that in some examples CNN 420 (e.g., one or more components of CNN 420) is implemented by other systems different from, or in addition to, perception system 402 such as planning system 404, localization system 406, and/or control system 408. While CNN 420 includes certain features as described herein, these features are provided for the purpose of illustration and are not intended to limit the present disclosure.

CNN 420 includes a plurality of convolution layers including first convolution layer 422, second convolution layer 424, and convolution layer 426. In some embodiments, CNN 420 includes sub-sampling layer 428 (sometimes referred to as a pooling layer). In some embodiments, sub-sampling layer 428 and/or other subsampling layers have a dimension (i.e., an amount of nodes) that is less than a dimension of an upstream system. By virtue of sub-sampling layer 428 having a dimension that is less than a dimension of an upstream layer, CNN 420 consolidates the amount of data associated with the initial input and/or the output of an upstream layer to thereby decrease the amount of computations necessary for CNN 420 to perform downstream convolution operations. Additionally, or alternatively, by virtue of sub-sampling layer 428 being associated with (e.g., configured to perform) at least one subsampling function (as described below with respect to FIGS. 4C and 4D), CNN 420 consolidates the amount of data associated with the initial input.

Perception system 402 performs convolution operations based on perception system 402 providing respective inputs and/or outputs associated with each of first convolution layer 422, second convolution layer 424, and convolution layer 426 to generate respective outputs. In some examples, perception system 402 implements CNN 420 based on perception system 402 providing data as input to first convolution layer 422, second convolution layer 424, and convolution layer 426. In such an example, perception system 402 provides the data as input to first convolution layer 422, second convolution layer 424, and convolution layer 426 based on perception system 402 receiving data from one or more different systems (e.g., one or more systems of a vehicle that is the same as or similar to vehicle 102), a remote AV system that is the same as or similar to remote AV system 114, a fleet management system that is the same as or similar to fleet management system 116, a V2I system that is the same as or similar to V2I system 118, and/or the like). A detailed description of convolution operations is included below with respect to FIG. 4C.

In some embodiments, perception system 402 provides data associated with an input (referred to as an initial input) to first convolution layer 422 and perception system 402 generates data associated with an output using first convolution layer 422. In some embodiments, perception system 402 provides an output generated by a convolution layer as input to a different convolution layer. For example, perception system 402 provides the output of first convolution layer 422 as input to sub-sampling layer 428, second convolution layer 424, and/or convolution layer 426. In such an example, first convolution layer 422 is referred to as an upstream layer and sub-sampling layer 428, second convolution layer 424, and/or convolution layer 426 are referred to as downstream layers. Similarly, in some embodiments perception system 402 provides the output of sub-sampling layer 428 to second convolution layer 424 and/or convolution layer 426 and, in this example, sub-sampling layer 428 would be referred to as an upstream layer and second convolution layer 424 and/or convolution layer 426 would be referred to as downstream layers.

In some embodiments, perception system 402 processes the data associated with the input provided to CNN 420 before perception system 402 provides the input to CNN 420. For example, perception system 402 processes the data associated with the input provided to CNN 420 based on perception system 402 normalizing sensor data (e.g., image data, lidar data, radar data, and/or the like).

In some embodiments, CNN 420 generates an output based on perception system 402 performing convolution operations associated with each convolution layer. In some examples, CNN 420 generates an output based on perception system 402 performing convolution operations associated with each convolution layer and an initial input. In some embodiments, perception system 402 generates the output and provides the output as fully connected layer 430. In some examples, perception system 402 provides the output of convolution layer 426 as fully connected layer 430, where fully connected layer 420 includes data associated with a plurality of feature values referred to as F1, F2 . . . FN. In this example, the output of convolution layer 426 includes data associated with a plurality of output feature values that represent a prediction.

In some embodiments, perception system 402 identifies a prediction from among a plurality of predictions based on perception system 402 identifying a feature value that is associated with the highest likelihood of being the correct prediction from among the plurality of predictions. For example, where fully connected layer 430 includes feature values F1, F2, . . . FN, and F1 is the greatest feature value, perception system 402 identifies the prediction associated with F1 as being the correct prediction from among the plurality of predictions. In some embodiments, perception system 402 trains CNN 420 to generate the prediction. In some examples, perception system 402 trains CNN 420 to generate the prediction based on perception system 402 providing training data associated with the prediction to CNN 420.

Referring now to FIGS. 4C and 4D, illustrated is a diagram of example operation of CNN 440 by perception system 402. In some embodiments, CNN 440 (e.g., one or more components of CNN 440) is the same as, or similar to, CNN 420 (e.g., one or more components of CNN 420) (see FIG. 4B).

At step 450, perception system 402 provides data associated with an image as input to CNN 440 (step 450). For example, as illustrated, perception system 402 provides the data associated with the image to CNN 440, where the image is a greyscale image represented as values stored in a 2D array. In some embodiments, the data associated with the image may include data associated with a color image, the color image represented as values stored in a 3D array. Additionally, or alternatively, the data associated with the image may include data associated with an infrared image, a radar image, and/or the like.

At step 455, CNN 440 performs a first convolution function. For example, CNN 440 performs the first convolution function based on CNN 440 providing the values representing the image as input to one or more neurons (not explicitly illustrated) included in first convolution layer 442. In this example, the values representing the image can correspond to values representing a region of the image (sometimes referred to as a receptive field). In some embodiments, each neuron is associated with a filter (not explicitly illustrated). A filter (sometimes referred to as a kernel) is representable as an array of values that corresponds in size to the values provided as input to the neuron. In one example, a filter may be configured to identify edges (e.g., horizontal lines, vertical lines, straight lines, and/or the like). In successive convolution layers, the filters associated with neurons may be configured to identify successively more complex patterns (e.g., arcs, objects, and/or the like).

In some embodiments, CNN 440 performs the first convolution function based on CNN 440 multiplying the values provided as input to each of the one or more neurons included in first convolution layer 442 with the values of the filter that corresponds to each of the one or more neurons. For example, CNN 440 can multiply the values provided as input to each of the one or more neurons included in first convolution layer 442 with the values of the filter that corresponds to each of the one or more neurons to generate a single value or an array of values as an output. In some embodiments, the collective output of the neurons of first convolution layer 442 is referred to as a convolved output. In some embodiments, where each neuron has the same filter, the convolved output is referred to as a feature map.

In some embodiments, CNN 440 provides the outputs of each neuron of first convolutional layer 442 to neurons of a downstream layer. For purposes of clarity, an upstream layer can be a layer that transmits data to a different layer (referred to as a downstream layer). For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of first subsampling layer 444. In some embodiments, CNN 440 adds a bias value to the aggregates of all the values provided to each neuron of the downstream layer. For example, CNN 440 adds a bias value to the aggregates of all the values provided to each neuron of first subsampling layer 444. In such an example, CNN 440 determines a final value to provide to each neuron of first subsampling layer 444 based on the aggregates of all the values provided to each neuron and an activation function associated with each neuron of first subsampling layer 444.

At step 460, CNN 440 performs a first subsampling function. For example, CNN 440 can perform a first subsampling function based on CNN 440 providing the values output by first convolution layer 442 to corresponding neurons of first subsampling layer 444. In some embodiments, CNN 440 performs the first subsampling function based on an aggregation function. In an example, CNN 440 performs the first subsampling function based on CNN 440 determining the maximum input among the values provided to a given neuron (referred to as a max pooling function). In another example, CNN 440 performs the first subsampling function based on CNN 440 determining the average input among the values provided to a given neuron (referred to as an average pooling function). In some embodiments, CNN 440 generates an output based on CNN 440 providing the values to each neuron of first subsampling layer 444, the output sometimes referred to as a subsampled convolved output.

At step 465, CNN 440 performs a second convolution function. In some embodiments, CNN 440 performs the second convolution function in a manner similar to how CNN 440 performed the first convolution function, described above. In some embodiments, CNN 440 performs the second convolution function based on CNN 440 providing the values output by first subsampling layer 444 as input to one or more neurons (not explicitly illustrated) included in second convolution layer 446. In some embodiments, each neuron of second convolution layer 446 is associated with a filter, as described above. The filter(s) associated with second convolution layer 446 may be configured to identify more complex patterns than the filter associated with first convolution layer 442, as described above.

In some embodiments, CNN 440 performs the second convolution function based on CNN 440 multiplying the values provided as input to each of the one or more neurons included in second convolution layer 446 with the values of the filter that corresponds to each of the one or more neurons. For example, CNN 440 can multiply the values provided as input to each of the one or more neurons included in second convolution layer 446 with the values of the filter that corresponds to each of the one or more neurons to generate a single value or an array of values as an output.

In some embodiments, CNN 440 provides the outputs of each neuron of second convolutional layer 446 to neurons of a downstream layer. For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of second subsampling layer 448. In some embodiments, CNN 440 adds a bias value to the aggregates of all the values provided to each neuron of the downstream layer. For example, CNN 440 adds a bias value to the aggregates of all the values provided to each neuron of second subsampling layer 448. In such an example, CNN 440 determines a final value to provide to each neuron of second subsampling layer 448 based on the aggregates of all the values provided to each neuron and an activation function associated with each neuron of second subsampling layer 448.

At step 470, CNN 440 performs a second subsampling function. For example, CNN 440 can perform a second subsampling function based on CNN 440 providing the values output by second convolution layer 446 to corresponding neurons of second subsampling layer 448. In some embodiments, CNN 440 performs the second subsampling function based on CNN 440 using an aggregation function. In an example, CNN 440 performs the first subsampling function based on CNN 440 determining the maximum input or an average input among the values provided to a given neuron, as described above. In some embodiments, CNN 440 generates an output based on CNN 440 providing the values to each neuron of second subsampling layer 448.

At step 475, CNN 440 provides the output of each neuron of second subsampling layer 448 to fully connected layers 449. For example, CNN 440 provides the output of each neuron of second subsampling layer 448 to fully connected layers 449 to cause fully connected layers 449 to generate an output (e.g., provide output 480). In some embodiments, fully connected layers 449 are configured to generate an output associated with a prediction (sometimes referred to as a classification). The prediction may include an indication that an object included in the image provided as input to CNN 440 includes an object, a set of objects, and/or the like. In some embodiments, perception system 402 performs one or more operations and/or provides the data associated with the prediction to a different system, described herein.

Referring now to FIG. 4E, shown is a diagram illustrating an example of a generative adversarial network (GAN) 482. GANs can be used, for example, to modify real data and generate simulated data for a given environment condition. “Discriminator loss” is used to train a more realistic generator. A generator 484 (for example a CNN generator) processes random noise 486 and uses condition embedding 488 to create generated sensor data 490. A discriminator 492 (e.g., a CNN discriminator) uses the generated sensor data 490 and real sensor data 494 (for example, from lidar and radar sensors) to identify discriminator loss 496 (e.g., identifying real or fake data).

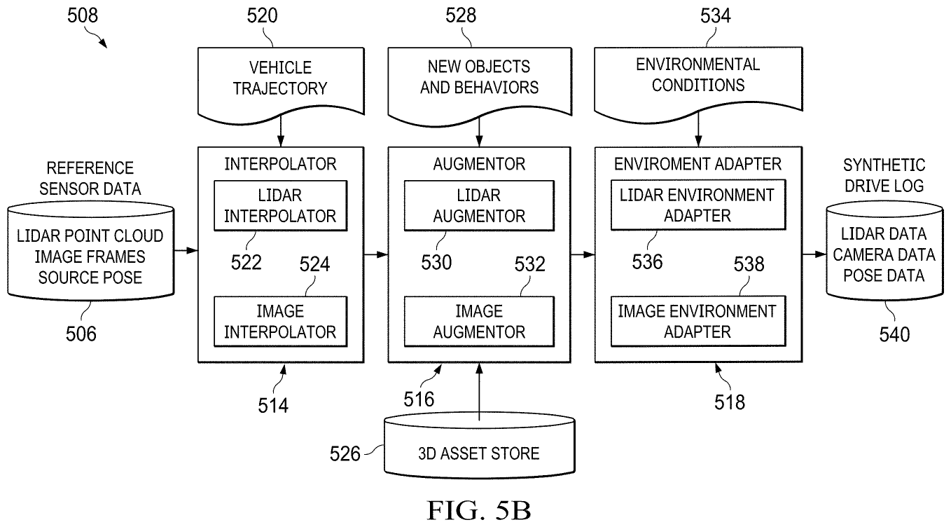

Referring now to FIGS. 5A-5C, illustrated are diagrams of an example of an implementation of an autonomous vehicle simulation system 500 of a process for high fidelity data-driven multi-modal simulation. In some embodiments, the autonomous vehicle simulation system 500 can be used for the generation of synthetic driving scenarios. The scenarios can be used in a simulated environment to support simulations for training device 300 and to make it possible for device 300 to operate safely in environments.

Referring to FIG. 5A, a real drive log 502 is used by a preprocessor 504 to generate reference sensor data 506. A purpose of the autonomous vehicle simulation system 500 is to generate base data including reference sensor data 506 that is needed for process 508.

The real drive log 502 includes, for example, lidar data, camera data, and pose data, such as for vehicle 200, collected during operation of vehicle 200. The lidar data includes detector-collected information from light reflected by objects in the environment after lidar sensors 202b are used to transmit pulsed light waves into a surrounding environment and onto the objects in the environment. The camera data includes image data captured by perception system 402 (and the autonomous system 202) from at least one camera 202a of the vehicle 200. Pose data includes position and orientation data for the vehicle 200, including the direction in which the vehicle 200 is pointed (generally toward objects in the surrounding environment).

The reference sensor data 506 that is generated by the preprocessor 504 includes point cloud data, image frames, and source pose data. As previously described, the point cloud data can be a combined point cloud representing the objects included in a field of view of the lidar sensors 202b. The image frames include, for each vehicle, a complete sequence of images captured by the cameras 202a of the vehicle 200. The source pose data includes pose information for the vehicle 200. The point cloud data, the image frames, and the source pose data can be correlated in the reference sensor data 506, such as to match the information by time. This time-based information can then serve as the input to process 508.

Referring to FIG. 5B, illustrated is a process 508 for generating synthetic drive log data 540 using reference sensor data 506. As previously described, the reference sensor data 506 includes point cloud data, image frames, and source pose data. In some embodiments, the process 508 uses at least three modules, including an interpolator 514, an augmenter 516, and an environment adaptor 518. It is noted that, although the modules 514, 516, and 518 are depicted in FIG. 5B as separate modules, one or more features of the modules can occur in parallel or simultaneously. For example, interpolation that is performed by the interpolator 514 can occur while the environment adaptor 518 adapts the synthetic drive log data 540 based on synthetic environmental conditions 534. Such processing can be accomplished by combined modules not depicted in FIG. 5B.

The interpolator 514 uses, as input, the reference sensor data 506 and vehicle trajectory data 520. The interpolator 514 can interpolate information in the reference sensor data 506 based on relationships between the different types of data. The relationships can include spatial relationships, such as a relationship between the position, orientation (or pose) of the vehicle, and temporal (time-based) relationships. Interpolations can occur between at least a portion of a first path (e.g., a previously-traveled path of the vehicle) and at least a portion of a second path (e.g., for which process 508 is to generate the synthetic sensor data, including the synthetic drive log data 540. In some embodiments, the interpolator 514 includes a lidar interpolator 522 (e.g., for interpolating between adjacent points in a lidar point cloud) and an image interpolator 524 (e.g., for interpolating between successive image frames).

The augmenter 516 augments lidar and images using information from 3D asset store 526 and new objects and behaviors 528. Augmentation is a primary part of process 508 because of the need to generate driving scenarios that are not already known by (or safely accomplishable/navigable by) the vehicle. These additional types of environmental cases are what simulators can teach vehicles 200 before the vehicles are exposed to real-world situations in which these types of cases may occur. In some embodiments, the augmenter 516 includes a lidar augmenter 530 (e.g., for augmenting lidar information, including in lidar point clouds) and an image augmenter 532 (e.g., for augmenting image frames, such as to add new 3D objects).

The environment adaptor 518 adapts driving scenarios based on environmental conditions 534. Environmental conditions can include, for example, different types of weather conditions, road conditions, time-of-day, and so on. The environmental conditions are varied by the process 508, for example, so that the synthetic drive log data 540 can be expanded to include types of conditions under which the vehicle 200 has not yet driven. An example can be environmental conditions that represent a driving in a snowstorm at night, after an accumulation of snow has already degraded road conditions in a significant way (e.g., a potentially slippery road, if recently plowed, or a snow-packed or snow-covered road if not yet plowed). In such situations, real cars parked along a road may be snow-covered, and lidar capabilities may be degraded due to reflectivity changes caused by snow. In some embodiments, the environment adaptor 518 includes a lidar environment adaptor 536 (e.g., for adapting lidar information based on environmental changes) and an image environment adaptor 532 (e.g., for augmenting images based on environmental changes, such as to add snow to an image).

Referring now to FIG. 5C, a process 550 shows how the synthetic drive log data 540 can be used for a simulated autonomous vehicle compute 552. Specifically, the scenarios representing different environmental changes produced by the process 508 can be used by simulators to simulate new types of driving scenarios for the vehicle 200. These new scenarios can be generated and simulated in preparation for the vehicle 200 for safely navigating similar conditions in the real world. An example is introducing the vehicle to snow-related conditions, where the vehicle 200 may already know how to safely navigate a similar route in the absence of snow conditions.

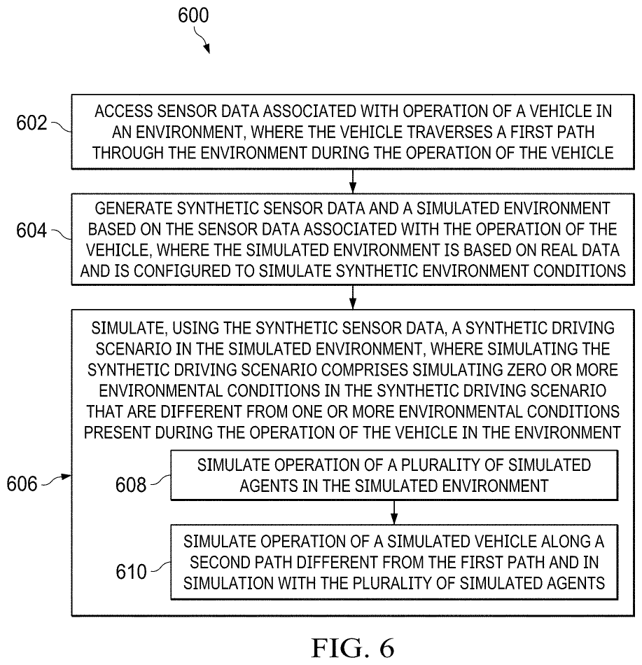

Referring now to FIG. 6, illustrated is a flowchart of a process 600 for high fidelity data-driven multi-modal simulation. In some embodiments, one or more of the steps described with respect to process 600 are performed (e.g., completely, partially, and/or the like) by the autonomous vehicle simulation system 500. Additionally, or alternatively, in some embodiments one or more steps described with respect to process 600 are performed (e.g., completely, partially, and/or the like) by another device or group of devices separate from or including autonomous vehicle simulation system 500.

At 602, sensor data associated with operation of a vehicle (e.g., vehicle 200) in an environment is accessed. The vehicle traverses a first path through the environment during the operation of the vehicle. For example, the path can be a path around objects 104a-104n. The sensor data can include, for example, image data and lidar data produced by at least one sensor of the vehicle (for example, lidar sensor 202b and radar sensor 202c), where generating the synthetic sensor data includes generating image data, lidar data, and radar data representing the synthetic driving scenario. In some embodiments, accessing the sensor data associated with the operation of the vehicle in the environment as the vehicle traverses the first path through the environment includes accessing at least one of lidar data associated with at least one point cloud, image data associated with at least one image, or radar data associated with at least one radar point cloud, the lidar data, image data, or radar data generated during the operation of the vehicle in the environment as the vehicle traverses the first path through the environment. For example, data captured by the lidar sensor 202b and the radar sensor 202c can be accessed, where the data represents a scenario traveled by a vehicle 102 through an area 108.

At 604, synthetic sensor data and a simulated environment are generated based on the sensor data associated with the operation of the vehicle (e.g., vehicles 200). The simulated environment is based on real data (e.g., collected by the autonomous systems 202 of plural vehicles 200) and is configured to simulate synthetic environment conditions. In some embodiments, generating the synthetic sensor data includes: generating synthetic sensor data based on the sensor data associated with the operation of the vehicle (for example, data from sensors 202b and 202c of the vehicle 200). Data representing at least one object (e.g., a static object, such as a tree or a building, or a dynamic object, such as a pedestrian or a vehicle) to be included in the synthetic driving scenario is accessed. An object can be, for example, another vehicle (either parked or moving) or a pedestrian, to name a few examples. The sensor data associated with the operation of the vehicle is augmented with the data representing at least one object, such as a new object not previously considered in the scenario, such as a bicycle. In some embodiments, at least one object includes a dynamic object, such as a bicycle or moving object. In some embodiments, the data representing at least one object includes motion data for the dynamic object, where the motion data includes trajectory data for the at least one object and limb movement data for pedestrians (such as if a pedestrian is waving their arms or simply walking and moving their legs). In some embodiments, generating the synthetic sensor data includes: receiving an indication of at least one environmental condition (e.g., one or more of weather condition, road condition, and time-of-day) to be included in the synthetic driving scenario. The sensor data (to be used for the synthetic driving scenario) is modified based on at least one environmental condition, such as modifying the scenario based on the presence of a bicycle, or the presence of snow, or the presence of a condition not previously considered by the vehicle. In some embodiments, the environment condition is not different from the input drive log, for example, adding an object to be considered by the vehicle 200 without changing weather conditions or the time-of-day. For example, modifying the sensor data based on at least one environmental condition can include processing the sensor data with at least one neural network (e.g., a generative adversarial network or a neural style transfer) configured to modify the sensor data based on at least one environmental condition.

In some embodiments, modifying the sensor data can include interpolating the sensor data based on a relationship (e.g., a spatial relationship, such as a relationship between the position, orientation or “pose” of the vehicle, or a temporal relationship). The relationship exists between at least a portion of the first path and at least a portion of the second path to generate the synthetic sensor data. As an example, the first and second paths may be identical in sections (e.g., overlapping sections) of the paths. However sensor data can be determined based on differences in the paths, such as if the second path is a particular distance away from the first path.

At 606, a synthetic driving scenario in the simulated environment is simulated using the synthetic sensor data. Simulating the synthetic driving scenario includes simulating zero or more environmental conditions in the synthetic driving scenario that are different from one or more environmental conditions present during the operation of the vehicle in the environment. The synthetic driving scenario can represent, for example, a scenario that the vehicle has yet to encounter in operation, such as a combination of objects that may be encountered in different lighting conditions, different weather conditions, and/or a different time-of-day.

At 608, operation of a plurality of simulated agents is simulated in the simulated environment. A simulated agent can be, for example, an instance of the autonomous vehicle for which the simulation is being run, or another autonomous vehicle. The simulated environment can determine how the vehicle may operate in the simulated environment, including the changes in direction and speed made by the vehicle in reaction to changes in the environment and/or other conditions.

At 610, operation of a simulated vehicle along a second path different from the first path is simulated in simulation with the plurality of simulated agents. In some embodiments, simulating the operation of the simulated vehicle includes using the same path with the plurality of simulated agents, such as if there is an opportunity to see if a vehicle might change its direction and/or speed when encountering a change in the scenario. In some embodiments, simulating the operation of the simulated vehicle includes using a different path with no inserted agents, such as to see what happens if the vehicle takes a different path around a parked car or a pedestrian.

In some embodiments, process 600 further includes steps for filtering objects based on environmental conditions. For example, at least one object in the environment is detected based on the sensor data. A determination is made whether at least one object is a static object or a dynamic object. In response to determining that at least one object is a dynamic object, data associated with the at least one object is filtered from the sensor data. The object may be a snow-covered, parked car, or a motionless bicycle that is next to the road (e.g., leaning against a tree) that is not likely to cause a safety issue to the vehicle under a present weather condition or time-of-day.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A method, comprising:
accessing, using at least one processor, sensor data associated with operation of a vehicle in an environment, wherein the vehicle traverses a first path through the environment during the operation of the vehicle;
generating, using the at least one processor, synthetic sensor data and a simulated environment based on the sensor data associated with the operation of the vehicle, wherein the simulated environment is based on real data and is configured to simulate synthetic environment conditions; and
simulating, using at least one processor and the synthetic sensor data, a synthetic driving scenario in the simulated environment, wherein simulating the synthetic driving scenario comprises:
simulating operation of a plurality of simulated agents in the simulated environment, and
simulating operation of a simulated vehicle along a second path different from the first path and in simulation with the plurality of simulated agents,
wherein simulating the synthetic driving scenario comprises simulating zero or more environmental conditions in the synthetic driving scenario that are different from one or more environmental conditions present during the operation of the vehicle in the environment.

2. The method of claim 1, wherein simulating the operation of the simulated vehicle includes using the same path with the plurality of simulated agents.

3. The method of claim 1, wherein simulating the operation of the simulated vehicle includes using a different path with no inserted agents.

4. The method of claim 1, wherein accessing the sensor data associated with the operation of the vehicle in the environment as the vehicle traverses the first path through the environment comprises:
accessing at least one of Light Detection And Ranging (LiDAR) data associated with at least one point cloud, image data associated with at least one image, or Radio Detection And Ranging (RADAR) data associated with at least one RADAR point cloud, the LiDAR data, image data, or RADAR data generated during the operation of the vehicle in the environment as the vehicle traverses the first path through the environment.

5. The method of claim 1, wherein the sensor data comprises image data and LiDAR data produced by at least one sensor of the vehicle, and wherein generating the synthetic sensor data includes generating image data, LiDAR data, and RADAR data representing the synthetic driving scenario.

6. The method of claim 1, wherein generating the synthetic sensor data includes:
generating synthetic sensor data based on the sensor data associated with the operation of the vehicle, including:
accessing data representing at least one object to be included in the synthetic driving scenario; and
augmenting the sensor data with the data representing at least one object.

7. The method of claim 1, wherein the at least one object includes a dynamic object, and wherein the data representing at least one object includes motion data for the dynamic object, wherein the motion data includes trajectory data for the at least one object and limb movement data for pedestrians.

8. The method of claim 1, wherein generating the synthetic sensor data includes:
receiving an indication of at least one environmental condition to be included in the synthetic driving scenario; and
modifying the sensor data based on at least one environmental condition.

9. The method of claim 1, wherein modifying the sensor data based on the at least one environmental condition includes:
processing the sensor data with at least one neural network configured to modify the sensor data based on at least one environmental condition.

10. The method of claim 1, wherein modifying the sensor data includes:
interpolating the sensor data based on a relationship between at least a portion of the first path and at least a portion of the second path to generate the synthetic sensor data.

11. The method of claim 1, further comprising:
detecting, based on the sensor data, at least one object in the environment;
determining whether at least one object is a static object or a dynamic object; and
in response to determining that at least one object is a dynamic object, filtering data associated with at least one object from the sensor data.

12. A system, comprising:
at least one processor; and
at least one computer-readable medium storing instructions which, when executed by the at least one processor, cause the at least one processor to perform operations comprising:
accessing, using at least one processor, sensor data associated with operation of a vehicle in an environment, wherein the vehicle traverses a first path through the environment during the operation of the vehicle;
generating, using the at least one processor, synthetic sensor data and a simulated environment based on the sensor data associated with the operation of the vehicle, wherein the simulated environment is based on real data and is configured to simulate synthetic environment conditions; and
simulating, using at least one processor and the synthetic sensor data, a synthetic driving scenario in the simulated environment, wherein simulating the synthetic driving scenario comprises:
simulating operation of a plurality of simulated agents in the simulated environment, and
simulating operation of a simulated vehicle along a second path different from the first path and in simulation with the plurality of simulated agents,
wherein simulating the synthetic driving scenario comprises simulating zero or more environmental conditions in the synthetic driving scenario that are different from one or more environmental conditions present during the operation of the vehicle in the environment.

13. At least one non-transitory computer-readable medium storing instructions which, when executed by at least one processor, cause the at least one processor to perform operations comprising:
accessing, using at least one processor, sensor data associated with operation of a vehicle in an environment, wherein the vehicle traverses a first path through the environment during the operation of the vehicle;
generating, using the at least one processor, synthetic sensor data and a simulated environment based on the sensor data associated with the operation of the vehicle, wherein the simulated environment is based on real data and is configured to simulate synthetic environment conditions; and
simulating, using at least one processor and the synthetic sensor data, a synthetic driving scenario in the simulated environment, wherein simulating the synthetic driving scenario comprises:
simulating operation of a plurality of simulated agents in the simulated environment, and
simulating operation of a simulated vehicle along a second path different from the first path and in simulation with the plurality of simulated agents,
wherein simulating the synthetic driving scenario comprises simulating zero or more environmental conditions in the synthetic driving scenario that are different from one or more environmental conditions present during the operation of the vehicle in the environment.

14. The system of claim 12, wherein simulating the operation of the simulated vehicle includes using the same path with the plurality of simulated agents.

15. The system of claim 12, wherein simulating the operation of the simulated vehicle includes using a different path with no inserted agents.

16. The system of claim 12, wherein accessing the sensor data associated with the operation of the vehicle in the environment as the vehicle traverses the first path through the environment comprises:
accessing at least one of Light Detection And Ranging (LiDAR) data associated with at least one point cloud, image data associated with at least one image, or Radio Detection And Ranging (RADAR) data associated with at least one RADAR point cloud, the LiDAR data, image data, or RADAR data generated during the operation of the vehicle in the environment as the vehicle traverses the first path through the environment.

17. The system of claim 12, wherein the sensor data comprises image data and LiDAR data produced by at least one sensor of the vehicle, and wherein generating the synthetic sensor data includes generating image data, LiDAR data, and RADAR data representing the synthetic driving scenario.

18. The at least one non-transitory computer-readable medium of claim 13, wherein simulating the operation of the simulated vehicle includes using the same path with the plurality of simulated agents.

19. The at least one non-transitory computer-readable medium of claim 13, wherein simulating the operation of the simulated vehicle includes using a different path with no inserted agents.

20. The at least one non-transitory computer-readable medium of claim 13, wherein accessing the sensor data associated with the operation of the vehicle in the environment as the vehicle traverses the first path through the environment comprises:
accessing at least one of Light Detection And Ranging (LiDAR) data associated with at least one point cloud, image data associated with at least one image, or Radio Detection And Ranging (RADAR) data associated with at least one RADAR point cloud, the LiDAR data, image data, or RADAR data generated during the operation of the vehicle in the environment as the vehicle traverses the first path through the environment.
